(19) United States
(12) Patent Application Publication
(10) Pub. No.: US 2026/0292698 A1
(43) Pub. Date: Sep. 24, 2026

(54) SIGNAL DETERMINATION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Xiaowei JIANG, Beijing (CN)

(21) Appl. No.: 19/490,852

(22) PCT Filed: Jun. 8, 2023
(86) PCT No.: PCT/CN2023/099245

§ 371 Date: Dec. 5, 2025

(51) Int. Cl. H04W 52/02; H04W 76/28

(52) U.S. Cl. CPC H04W 52/0235; H04W 76/28

(57) ABSTRACT

A method for determining a signal is provided. The method for determining the signal is performed by a user equipment (UE), and the method for determining the signal includes: determining whether a wake-up signal associated with cell discontinuous transmission is valid or invalid according to a communication protocol provision or configuration information from a network device.

### CROSS-REFERENCE TO RELATED APPLICATION

The present application is a U.S. National Stage of International Application No. PCT/CN2023/099245, filed on Jun. 8, 2023, the contents of all of which are incorporated herein by reference in their entirety for all purposes.

### BACKGROUND OF THE INVENTION

Main application scenarios of a 5th generation (5G) mobile communication technology include: enhanced mobile broadband (eMBB), ultra-reliable and low latency communications (URLLC), and massive machine type communication (mMTC). The eMBB aims at enabling users to access multimedia content, services, and data, and the demand for the eMBB is growing very rapidly. Typical applications for the URLLC include: industrial automation, power automation, telemedicine operations (surgery), transportation safety and security, etc. Typical features of the mMTC include: a high connection density, a small data volume, a delay-insensitive service, and a low-cost and long-lifetime module, etc.

### SUMMARY OF THE INVENTION

The present disclosure relates to, but is not limited to, the field of wireless communication technologies, and in particular to a method and device for determining a signal, a communication device, and a storage medium.

A first aspect of the embodiments of the present disclosure provides a method for determining a signal. The method for determining a signal, performed by a user equipment (UE), includes:
determining whether a wake-up signal associated with cell discontinuous transmission is valid or invalid according to a communication protocol provision or configuration information from a network device.

A second aspect of the embodiments of the present disclosure provides a method for determining a signal, performed by a network device, including:
transmitting configuration information, where the configuration information is configured to indicate whether a wake-up signal associated with cell discontinuous transmission is valid or invalid.

A third aspect of the embodiments of the present disclosure provides a device for determining a signal, arranged in a user equipment (UE), including:
a processing module configured to determine whether a wake-up signal associated with cell discontinuous transmission is valid or invalid according to a communication protocol provision or configuration information from a network device.

A fourth aspect of the embodiments of the present disclosure provides a device for determining a signal, arranged in a network device, including:
a transceiver module configured to transmit configuration information, where the configuration information is configured to indicate whether a wake-up signal associated with cell discontinuous transmission is valid or invalid.

A fifth aspect of the embodiments of the present disclosure provides a communication system, including a network device and a user equipment (UE), where
the UE performs the method for determining the signal as provided in the first aspect; and
the network device performs the method for determining the signal as provided in the second aspect.

A sixth aspect of the embodiments of the present disclosure provides a communication device, including one or more processors, a transceiver, a memory, and an executable program stored on the memory and executable by the one or more processors, where the executable program, when executed by the one or more processors, causes the communication device to perform the method for determining the signal as provided in the first aspect or the second aspect.

A seventh aspect of the embodiments of the present disclosure provides a non-transitory computer-readable storage medium, storing an executable program, where the executable program, when executed by one or more processors of a communication device, causes the communication device to perform the method for determining the signal as provided in the first aspect or the second aspect.

### BRIEF DESCRIPTION OF DRAWINGS

Accompanying drawings in the present disclosure are incorporated into the specification, constitute a part of the specification, and show principles consistent with embodiments of the present disclosure and used together with the specification to explain the embodiments of the present disclosure.

FIG. 1 is a schematic architectural diagram of a wireless communication system according to an example.

FIG. 2 is a schematic diagram of a timing sequence of a wake-up signal according to an example.

FIG. 3 is a schematic diagram of a timing sequence of a wake-up signal according to an example.

FIG. 4 is a schematic diagram of a process for determining a signal according to an example.

FIG. 5 is a schematic diagram of a process for determining a signal according to an example.

FIG. 6 is a schematic diagram of a process for determining a signal according to an example.

FIG. 7 is a schematic diagram of a process for determining a signal according to an example.

FIG. 8 is a schematic structural diagram of a device for determining a signal according to an example.

FIG. 9 is a schematic structural diagram of a device for determining a signal according to an example.

FIG. 10 is a schematic structural diagram of a UE according to an example.

FIG. 11 is a schematic structural diagram of a communication device according to an example.

### DETAILED DESCRIPTION OF THE INVENTION

Examples are illustrated in detail in the present disclosure, and their instances are shown in accompanying drawings. When the following description refers to the accompanying drawings, unless otherwise indicated, the same numbers in different accompanying drawings indicate the same or similar elements. Implementations described in the following examples do not represent all implementations consistent with embodiments of the present disclosure. Instead, they are merely instances of devices and methods consistent with some aspects of the embodiments of the present disclosure.

Terms used in the embodiments of the present disclosure are merely for the purpose of describing specific embodiments, and are not intended to limit the embodiments of the present disclosure. Singular forms “one,” “said,” and “the” used in the present disclosure are also intended to include plural forms unless the context clearly indicates other meanings. It is also to be understood that a term “and/or” as used in the present disclosure refers to and contains one listed item, or any or all combinations of more associated listed items.

It is to be understood that although terms first, second, third, etc. may be used to describe various information in the embodiments of the present disclosure, such information is not to be limited to these terms. These terms are merely used to distinguish the same type of information from each other. For example, without departing from the scope of the embodiments of the present disclosure, first information may also be referred to as second information, and similarly, the second information may also be referred to as the first information. Depending on the context, for example, words “in a case where” as used in the present disclosure may be interpreted as “at the time,” “when,” or “in response to determining.”

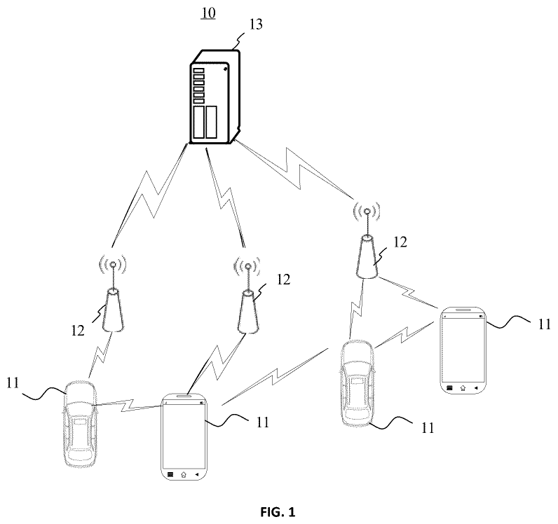

Referring to FIG. 1, it shows a schematic architectural diagram of a wireless communication system provided by an embodiment of the present disclosure. As shown in FIG. 1, the wireless communication system 10 is a communication system based on a cellular mobile communication technology. The wireless communication system 10 may include a plurality of UEs 11 and a plurality of network devices 12.

The wireless communication system 10 may be a 4th generation mobile communication (4G) system, also called a long-term evolution (LTE) system. Alternatively, the wireless communication system 10 may also be a 5G system, also called a new radio (NR) system or 5G NR system. Alternatively, the wireless communication system 10 may also be a next-generation system of the 5G system. An access network in the 5G system may be called a new generation-radio access network (NG-RAN). Alternatively, the wireless communication system 10 may be a machine type communication (MTC) system.

The UE 11 may refer to devices that provide a user with at least one of speech or data connectivity. The UE 11 may communicate with one or more core networks via a radio access network (RAN). The UE 11 may be internet-of-things UE, such as sensor devices, mobile phones (or called “cellular” phones), and computers with the internet-of-things UE. For example, the UE may be fixed, portable, pocket-size, handheld, computer built-in, or vehicle-mounted devices, for example, the UE may be a station (STA), a subscriber unit, a subscriber station, a mobile station, a mobile, a remote station, an access point, remote UE (remote terminal), access UE (access terminal), a user terminal, a user agent, a user device, or user equipment (UE). Alternatively, the UE 11 may also be unmanned aircraft devices. Alternatively, the UE 11 may also be the vehicle-mounted devices, such as a trip computer with a wireless communication function, or a wireless communication device connected with an external trip computer. Alternatively, the UE 11 may also be roadside devices, such as a street lamp, a signal light, or other roadside devices with wireless communication functions.

The network device 12 may include an access network device. In some examples, the network device 12 may further include a core network device. The access network device may be an evolved access device (eNB) adopted in the 4G system. Alternatively, the access network device may also be an access device (gNB) adopting central and distributed architectures in the 5G system. In a case where the access network device adopts the centralized and distributed architecture, it typically includes a central unit (CU) and at least two distributed units (DUs). Protocol stacks of a packet data convergence protocol (PDCP) layer, a radio link control (RLC) layer, and a media access control (MAC) layer are disposed in the central unit. Further, protocol stacks of physical (PHY) layers are disposed in the distributed units. Specific implementations of the access network device are not limited to the embodiment of the present disclosure.

The network device 12 and the UE 11 may establish a wireless connection through wireless radio. In different implementations, the wireless radio is wireless radio based on the 4th generation mobile communication (4G) standard. Alternatively, the wireless radio is wireless radio based on the 5th generation mobile communication (5G) standard, such as new radio. Alternatively, the wireless radio may also be a wireless radio based on the next-generation mobile communication standard of 5G.

With the introduction of 5G technology into 3GPP standard version 15 (R15), the energy consumption of a 5G base station is four times that of a long-term evolution (LTE) base station, so network energy saving is an important tool for operators to reduce the cost of operating a 5G system.

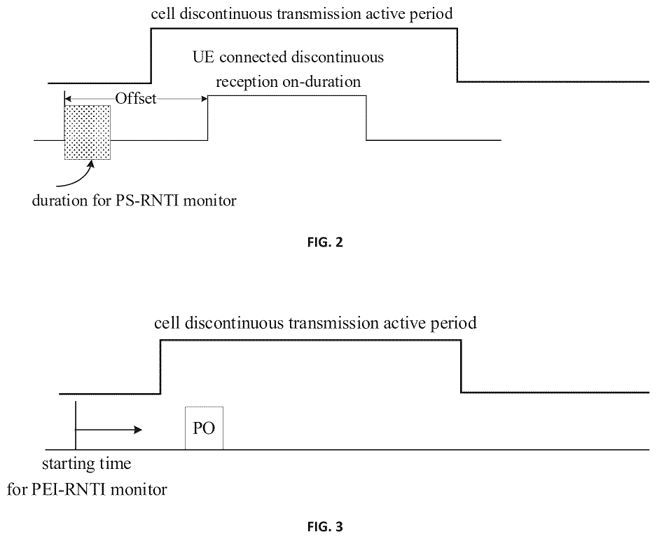

In the 3GPP standard version 16 (R16), as shown in FIG. 2, a wake-up signal (WUS) is introduced in order to save energy for the radio resource control (RRC) connected state user equipment (UE). An offset preceding an on duration of UE connected discontinuous reception (C-DRX) defines a monitoring duration for transmitting the WUS. The WUS, i.e., downlink control information (DCI) 2-6, is transmitted during this WUS monitoring duration, is scrambled by a power saving radio network temporary identity (PS-RNTI), and is configured to indicate whether the UE wakes up to monitor a physical downlink control channel (PDCCH) during the following UE C-DRX on-duration.

In the 3GPP standard version 17 (R17), as shown in FIG. 3, a paging wake-up signal (paging WUS) is introduced in order to save energy for the UE in an RRC idle state/RRC non-active state. That is, the paging WUS, i.e., a paging early indication (PEI), starts to be transmitted at a certain moment before a paging occasion (PO), which is configured to indicate whether the UE monitors paging scheduling information at that PO. The PEI is DCI 2-7, scrambled by a paging early indication radio network temporary identifier (PEI-RNTI).

In the 3GPP standard version 18 (R18), in order to reduce network energy consumption, the topic of network energy saving (NES) is initiated, and four types of NES functions supported by the standard are as follows:
synchronization signal block (SSB)-less SCell;
cell discontinuous transmission (DTX)/ discontinuous reception (DRX);
antenna port adaptation; and
physical downlink shared channel (PDSCH) transmission power adaptation.

A base station, R18 UE, and traditional UE are not affected by an NES mode in the idle/non-active state random access channel (RACH), paging, and a system information block (SIB). The UE can obtain Cell DTX/DRX configuration information configured on a network device. Work is performed based on the Cell DTX/DRX configuration. Configuration information for the Cell DTX/DRX configuration information can include a period, an offset, and an on duration/time, etc.

In an implementation, cell discontinuous transmission (Cell DTX) may include an active duration and a non-active duration. During the active duration, the base station performs normal communication transmission in a cell. During the non-active duration, the base station may be in a dormant state and does not perform communication transmission in the cell.

In a case where the network enters in an energy saving mode, i.e., the NES mode, the cell periodically does not perform at least one of transmission or reception at certain intervals, i.e., cell DTX/DRX, but a master information block (MIB), a system information block (SIB), paging, and a random access channel (RACH) can be transmitted and received.

During the non-active duration of the Cell DTX, a network speed may not be used to transmit PDSCH, physical uplink shared channel (PUSCH) scheduling, PDSCH, semi-persistent scheduling (SPS), and so on.

Whether the UE needs to monitor the WUS in the network energy saving mode at that time is not defined. In the present disclosure, the WUS may include a UE DRX WUS associated with connected state UE, and a paging WUS associated with idle state UE/non-active state UE.

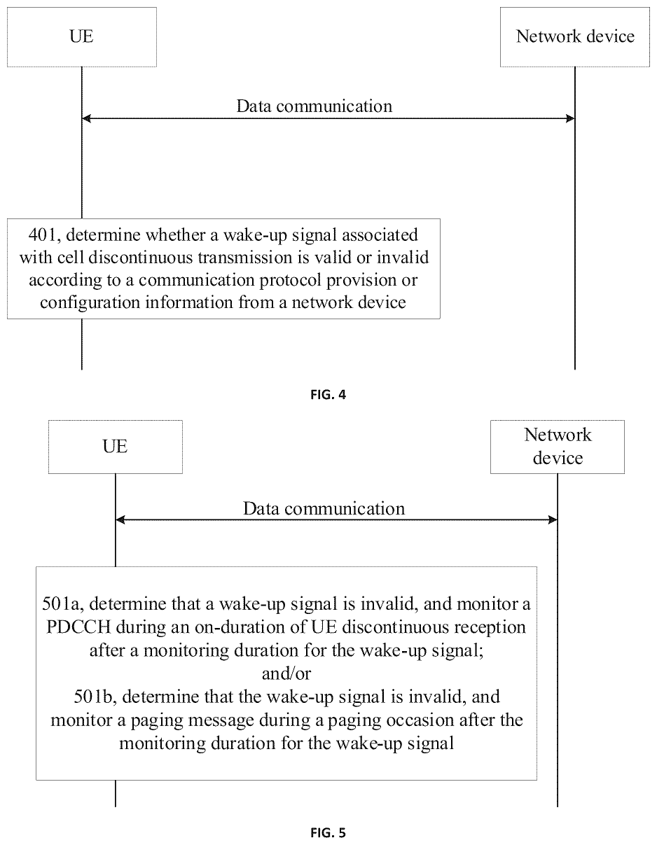

As shown in FIG. 4, an embodiment of the present disclosure provides a method for determining a signal, performed by a UE, including step 401.

In step 401, whether a wake-up signal associated with cell discontinuous transmission is valid or invalid is determined according to a communication protocol provision or configuration information from a network device.

In an implementation, the network device may be an access network device or a core network device. Signal determination between the core network device and the UE can be realized by the access network device.

In an implementation, the wake-up signal associated with the cell discontinuous transmission includes, but is not limited to, at least one of the following:
a wake-up signal transmitted by the network device in a cell that starts cell discontinuous transmission;
a wake-up signal transmitted by the network device during an active duration of the cell discontinuous transmission; or
a wake-up signal transmitted by the network device during a non-active duration of the cell discontinuous transmission.

In an embodiment, the wake-up signal includes at least one of the following:
a first wake-up signal configured to indicate whether the UE wakes up during an on-duration of a predetermined UE discontinuous reception; or
a second wake-up signal configured to indicate whether the UE wakes up during a predetermined paging occasion.

In an implementation, the first wake-up signal may be monitored by the UE that is in an RRC connected state.

In an implementation, the second wake-up signal may be monitored by the UE that is in an RRC unconnected state, and the RRC unconnected state may include at least one of an RRC idle state or an RRC non-active state.

In the present disclosure, the first wake-up signal may be a UE connected discontinuous reception (C-DRX) WUS (referred to as a C-DRX WUS, a DRX WUS, or a UE DRX WUS) for indicating whether the UE wakes up during the on-duration of the predetermined UE discontinuous reception and monitors the PDCCH. The on-duration of the predetermined UE discontinuous reception may be the on-duration of the UE discontinuous reception adjacent to the UE DRX WUS.

In the present disclosure, the first wake-up signal may be a paging wake-up signal (paging WUS), i.e., PEI, configured to indicate whether the UE wakes up during a predetermined paging occasion and monitors paging scheduling information. The predetermined paging occasion may be a paging occasion adjacent to the PEI.

In an implementation, the wake-up signal being invalid may include the wake-up signal being configured not to wake up the UE.

In an implementation, the UE DRX WUS is invalid, i.e., the UE DRX WUS is not configured to indicate whether the UE wakes up during the on-duration of the predetermined UE discontinuous reception and monitors the PDCCH. Thus, the UE may no longer monitor the UE DRX WUS.

In an implementation, the PEI is invalid, i.e., the PEI is not configured to indicate whether the UE wakes up during the predetermined paging occasion and monitors the paging scheduling information. Thus, the UE may no longer monitor the PEI.

In an implementation, whether the wake-up signal associated with cell discontinuous transmission is valid or invalid may be specified by a communication protocol. For example, the communication protocol may specify that a wake-up signal transmitted by the network device during the active duration of the cell discontinuous transmission is invalid.

In an implementation, the network device may transmit configuration information to the UE to indicate whether the wake-up signal associated with the cell discontinuous transmission is valid or invalid. For example, the configuration information may indicate that the wake-up signal transmitted by the network device during the active duration of the cell discontinuous transmission is invalid.

The wake-up signal may have a monitoring duration. The monitoring duration may be pre-configured by the network device or specified by the communication protocol. The network device can transmit the wake-up signal during the monitoring duration.

In an implementation, the monitoring duration may include the monitoring duration for the UE DRX WUS. In an implementation, the monitoring duration may include a time period from a starting time for the PEI monitoring to a starting time for a PEI-associated PO. The PEI-associated PO may include a first PO after the PEI, i.e., the PO after the PEI that is adjacent to the PEI.

In a case where the wake-up signal is valid, the UE can monitor the wake-up signal during the monitoring duration for the wake-up signal.

In this way, the UE may determine whether the wake-up signal associated with the cell discontinuous transmission is valid or invalid according to the communication protocol provision or an indication of the configuration information. It is to reduce the cases where the UE does not monitor the wake-up signal and/or invalidly monitors the wake-up signal due to uncertainty as to whether the wake-up signal is valid or not.

In an embodiment, determining whether the wake-up signal associated with the cell discontinuous transmission is valid or invalid includes:
determining whether the wake-up signal is valid or invalid in a case where the cell is configured with the cell discontinuous transmission.

The communication protocol may specify, or, the configuration information transmitted by the network device may indicate that the wake-up signal is valid or invalid in a case where the cell is configured with the cell discontinuous transmission.

In an implementation, the network device may still transmit the wake-up signal regardless of whether the wake-up signal is valid or invalid.

In an implementation, in a case where the wake-up signal is invalid, the network device may not transmit the wake-up signal.

In an embodiment, determining whether the wake-up signal is valid or invalid in a case where the cell is configured with the cell discontinuous transmission includes at least one of the following:
determining whether the wake-up signal is valid or invalid during the non-active duration of the cell discontinuous transmission in a case where the cell is configured with the cell discontinuous transmission; or
determining whether the wake-up signal is valid or invalid during the non-active duration of the cell discontinuous transmission in a case where the cell is configured with the cell discontinuous transmission and a configuration of the cell discontinuous transmission is in an active state.

In an implementation, the cell discontinuous transmission may be in a form of configuration-as-activation, i.e., in a case where the cell is configured with the cell discontinuous transmission, the cell may perform communication using the cell discontinuous transmission. The communication protocol may specify, or, the configuration information transmitted by the network device may indicate that the wake-up signal is valid or invalid during the non-active duration of the cell discontinuous transmission in a case where the cell is configured with the cell discontinuous transmission.

In an implementation, the cell discontinuous transmission configured for the cell needs to be activated for implementation, i.e., in a case where the cell is configured with the cell discontinuous transmission, this configuration needs to be activated (e.g., activated by an activation command). After activation of the configuration, the cell may perform communication using the cell discontinuous transmission. The communication protocol may specify, or, the configuration information transmitted by the network device may indicate that in a case where the cell is configured with the cell discontinuous transmission and this configuration is activated, the wake-up signal is valid or invalid during the non-active duration of the cell discontinuous transmission.

For example, in a case where the wake-up signal (at least one of the UE DRX WUS or the PEI) is valid during the non-active duration of the cell discontinuous transmission, then:
1. the UE DRX WUS is not affected by the operation of the cell discontinuous transmission, i.e., the UE DRX WUS is transmitted normally during the non-active duration of the cell discontinuous transmission. The UE may monitor the UE DRX WUS during the non-active duration of the cell discontinuous transmission.
2. The PEI is not affected by the operation of the cell discontinuous transmission, i.e., the PEI is transmitted normally during the non-active duration of the cell discontinuous transmission. The UE may monitor the PEI during the non-active duration of the cell discontinuous transmission.

For example, the UE determines whether the PEI is affected by the operation of the cell discontinuous transmission based on the indication of the configuration information from the network device. In a case where the UE determines that the PEI is affected by the operation of the cell discontinuous transmission, the PEI is not monitored during the non-active duration of the cell discontinuous transmission.

In an embodiment, determining whether the wake-up signal associated with the cell discontinuous transmission is valid or invalid includes:
determining whether the wake-up signal is valid or invalid in a case where the monitoring duration for the wake-up signal and the non-active duration of the cell discontinuous transmission have an overlapping duration in the time domain.

In the present disclosure, the wake-up signal includes the UE DRX WUS and the PEI.

In an implementation, as shown in FIG. 2, the monitoring duration may include the monitoring duration for the UE DRX WUS (i.e., a duration for PS-RNTI monitor). The monitoring duration for the UE DRX WUS may be configured by the network device to the UE.

In an implementation, as shown in FIG. 3, the monitoring duration may include a time period from the starting time for the PEI monitoring (i.e., a starting time for PEI-RNTI monitor) to the starting time for the PEI-associated PO. The PEI-associated PO may include the first PO after the PEI, i.e., the PO after the PEI that is adjacent to the PEI.

The UE may determine whether the wake-up signal is valid in a case where the monitoring duration for the wake-up signal and the non-active duration of the cell discontinuous transmission have the overlapping duration in the time domain, according to the communication protocol provision or the indication of the configuration information transmitted by the network device.

In an embodiment, a length of the overlapping duration is less than a length of the monitoring duration;
or,
the length of the overlapping duration is equal to the length of the monitoring duration.

In the present disclosure, the length of the overlapping duration is less than the length of the monitoring duration, i.e., a part of the monitoring duration for the wake-up signal overlaps with the non-active duration of the cell discontinuous transmission. The length of the overlapping duration is equal to the length of the monitoring duration, i.e., the entire monitoring duration for the wake-up signal overlaps with the non-active duration of the cell discontinuous transmission, i.e., the monitoring duration for the wake-up signal falls within the non-active duration of the cell discontinuous transmission.

In an embodiment, determining whether the wake-up signal is valid or invalid in a case where the monitoring duration for the wake-up signal and the non-active duration of the cell discontinuous transmission have the overlapping duration in the time domain includes at least one of the following:
determining whether the wake-up signal during the monitoring duration is valid or invalid in a case where the monitoring duration for the wake-up signal and the non-active duration of the cell discontinuous transmission have the overlapping duration in the time domain; or
determining whether the wake-up signal during the non-active duration of the cell discontinuous transmission is valid or invalid in a case where the monitoring duration for the wake-up signal and the non-active duration of the cell discontinuous transmission have the overlapping duration in the time domain.

The UE may determine a duration in which the wake-up signal is valid or invalid in a case where the monitoring duration for the wake-up signal and the non-active duration of the cell discontinuous transmission have the overlapping duration in the time domain, according to the communication protocol provision or the indication of configuration information transmitted by the network device.

For example, in a case where the monitoring duration for the UE DRX WUS falls within the non-active duration of the cell discontinuous transmission, and/or a part of the monitoring duration for the UE DRX WUS falls within the non-active duration of the cell discontinuous transmission, the UE considers that the UE DRX WUS transmission in the monitoring duration for the UE DRX WUS is invalid, and the UE may not monitor the UE DRX WUS. The UE may monitor the PDCCH during a following UE DRX on-duration.

For example, in a case where a part of the monitoring duration for the UE DRX WUS falls within the non-active duration of the cell discontinuous transmission, the UE considers that the WUS transmission in the monitoring duration for the UE DRX WUS is valid and monitors the WUS (i.e., DCI 2-6 scrambled by a PS-RNTI) during the monitoring duration for the WUS. The UE may decide, based on a WUS indication, whether to monitor the PDCCH during the following UE DRX on-duration.

For example, in a case where the starting time for the paging wake-up signal (paging WUS) (i.e., PEI) falls within the non-active duration of the cell discontinuous transmission, or in a case where a part of a period from the starting time for the PEI to the PO reception falls within the non-active duration of the cell discontinuous transmission, or in a case where the entire period from the starting time for the PEI to the PO reception falls within the non-active duration of the cell discontinuous transmission, the UE considers that the PEI transmission in the PEI is invalid. The UE may not monitor the PEI and monitor the PDCCH during the following PO.

For example, in a case where a part of the period from the starting time for the paging wake-up signal (paging WUS) (i.e., PEI) to the PO reception falls within the non-active duration of the cell discontinuous transmission, the UE considers that the PEI is valid, starts to monitor the PEI (i.e., the DCI 2-7 scrambled by a PEI-RNTI) at the starting time for the PEI, and determines, based on the WUS indication, whether to monitor the PDCCH during the following PO.

For example, based on a network device configuration indication, for scenarios where a part of a period from the starting time for the paging wake-up signal (paging WUS) (i.e., PEI) to the PO reception falls within the non-active duration of the cell discontinuous transmission, and/or the entire period from the starting time for the PEI to the PO reception falls within the non-active duration of the cell discontinuous transmission, the UE determines whether the PEI is affected by the operation of the cell discontinuous transmission. In a case where the UE determines that the PEI is affected by the operation of the cell discontinuous transmission, the PEI is not monitored during the non-active duration of the cell discontinuous transmission.

In the example, the duration from the starting time for the PEI to the PO reception is the monitoring duration for the PEI.

In an embodiment, determining whether the wake-up signal during the monitoring duration is valid or invalid in a case where the monitoring duration for the wake-up signal and the non-active duration of the cell discontinuous transmission have the overlapping duration in the time domain includes at least one of the following:
determining whether the wake-up signal transmitted during a duration, during the monitoring duration for the wake-up signal, in which the monitoring duration and the non-active duration do not overlap in the time domain is valid or invalid, in a case where the monitoring duration for the wake-up signal and the non-active duration of the cell discontinuous transmission have the overlapping duration in the time domain; or
determining whether the wake-up signal is valid or invalid during the overlapping duration in a case where the monitoring duration for the wake-up signal and the non-active duration of the cell discontinuous transmission have the overlapping duration in the time domain.

The communication protocol may specify, or, the configuration information transmitted by the network device may indicate at least one of whether the wake-up signal is valid during the overlapping duration of the monitoring duration for the wake-up signal and the non-active duration of the cell discontinuous transmission, or whether the wake-up signal is valid during a non-overlapping part of the monitoring duration for the wake-up signal.

For example, in a case where a part of the period from the starting time for the paging wake-up signal (paging WUS) (i.e., PEI) to the PO reception falls within the non-active duration of the cell discontinuous transmission, the UE considers that the PEI is valid, and monitors the PEI (i.e., DCI 2-7 scrambled by a PEI-RNTI) after the starting time for the PEI and during an active duration of the cell discontinuous transmission. That is, the PEI is valid during the active duration of the cell discontinuous transmission, and the UE may monitor the PEI within an intersection of the monitoring duration for the PEI and the active duration of the cell discontinuous transmission. The UE may decide, based on a PEI indication, whether to monitor the PDCCH during a following PO duration.

As shown in FIG. 5, an embodiment of the present disclosure provides a method for determining a signal, performed by a UE, including at least one of the following steps 501a and 501b.

In step 501a, it is determined that a wake-up signal is invalid, and a PDCCH is monitored during an on-duration of the UE discontinuous reception after a monitoring duration for the wake-up signal.

In step 501b, it is determined that the wake-up signal is invalid, and a paging message is monitored during the paging occasion after the monitoring duration for the wake-up signal.

The on-duration of the UE discontinuous reception after the monitoring duration for the wake-up signal may be an on-duration of a predetermined UE discontinuous reception associated with the wake-up signal.

The paging occasion after the monitoring duration for the wake-up signal may be a predetermined paging occasion associated with the wake-up signal. Monitoring the paging message may include: monitoring paging scheduling information for the paging message, and then receiving the paging message according to the paging scheduling information.

In an implementation, the wake-up signal may be the UE DRX WUS. In a case where the UE DRX WUS is invalid, the UE DRX WUS is not configured to indicate whether the UE wakes up during the on-duration of the UE discontinuous reception after the UE DRX WUS and monitors the PDCCH. Thus, the UE cannot determine, according to the UE DRX WUS, whether it needs to monitor the PDCCH during the on-duration of the UE discontinuous reception after the UE DRX WUS. To reduce the UE's missed reception of scheduling information transmitted by the network device, the UE may wake up and monitor the PDCCH during the on-duration of the UE discontinuous reception after the UE DRX WUS. In this way, a situation in which the scheduling information transmitted by the network device is missed due to an invalid wake-up signal may be reduced.

In an implementation, the wake-up signal may be a PEI. In a case where the PEI is invalid, the PEI is not configured to indicate whether the UE wakes up during a PO after the PEI and monitors the paging message. Thus, the UE cannot determine whether it needs to monitor the paging message during the PO after the PEI according to the PEI. To reduce UE's missed reception of the paging message transmitted by the network device, the UE may wake up during the PO after the PEI, and monitor the paging message. In this way, a situation of missed reception of the paging message transmitted by the network device due to invalidness of the wake-up signal may be reduced.

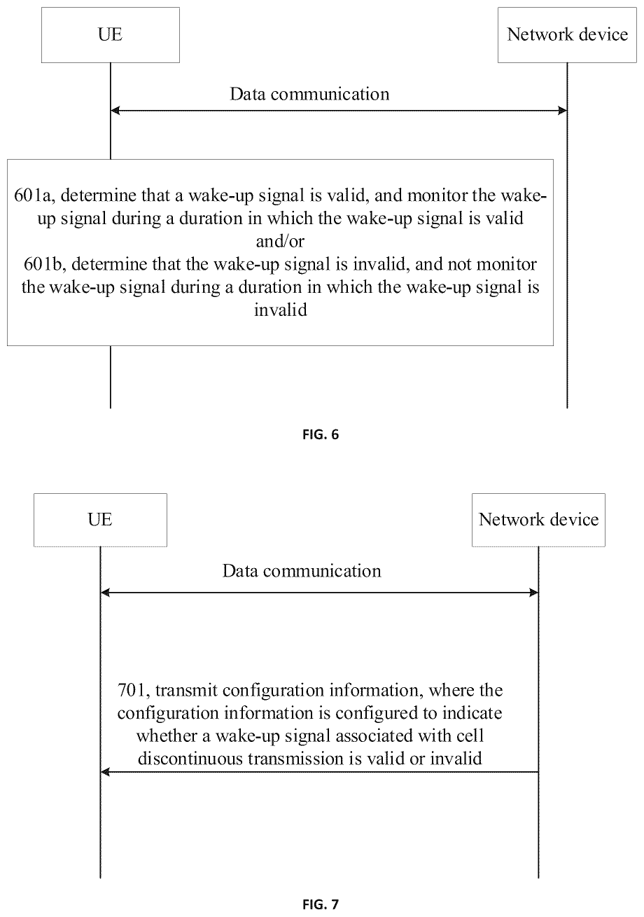

As shown in FIG. 6, an embodiment of the present disclosure provides a method for determining a signal, performed by a UE, including at least one of the following steps 601a and 601b.

In step 601a, it is determined that the wake-up signal is valid, and the wake-up signal is monitored during a duration in which the wake-up signal is valid.

In step 601b, it is determined that the wake-up signal is invalid, and the wake-up signal is not monitored during a duration in which the wake-up signal is invalid.

The UE may determine a duration in which the wake-up signal is valid and/or invalid based on the communication protocol or configuration information.

For example, the UE may determine, based on the communication protocol or the configuration information, that the wake-up signal is valid during the non-active duration of the cell discontinuous transmission, and then the non-active duration of the cell discontinuous transmission may be a duration in which the wake-up signal is valid. The UE may monitor the wake-up signal during the duration in which the wake-up signal is valid, i.e., the non-active duration of the cell discontinuous transmission.

In an implementation, the UE may monitor the wake-up signal during the duration in which the wake-up signal is valid may include: the UE may monitor the wake-up signal within an intersection of the valid duration for the wake-up signal and the monitoring duration for the wake-up signal.

For example, the UE may determine, based on the communication protocol or the configuration information, that the wake-up signal is invalid during the non-active duration of the cell discontinuous transmission, and then the non-active duration of the cell discontinuous transmission may be the duration in which the wake-up signal is invalid. The UE may not monitor the wake-up signal during the duration in which the wake-up signal is invalid, i.e., the non-active duration of the cell discontinuous transmission.

In an implementation, the network device may transmit the wake-up signal during the duration in which the wake-up signal is valid.

In an implementation, the network device may not transmit the wake-up signal during the duration in which the wake-up signal is invalid.

As shown in FIG. 7, an embodiment of the present disclosure provides a method for determining a signal, performed by a network device, including step 701.

In step 701, configuration information is transmitted, where the configuration information is configured to indicate whether a wake-up signal associated with cell discontinuous transmission is valid or invalid.

In an implementation, the network device may be an access network device or a core network device. Signal determination between the core network device and the UE can be realized by the access network device.

In an implementation, the wake-up signal associated with the cell discontinuous transmission includes, but is not limited to, at least one of the following:
a wake-up signal transmitted by the network device in a cell that starts the cell discontinuous transmission;
a wake-up signal transmitted by the network device during an active duration of the cell discontinuous transmission; or
a wake-up signal transmitted by the network device during a non-active duration of the cell discontinuous transmission.

In an embodiment, the wake-up signal includes at least one of the following:
a first wake-up signal configured to indicate whether the UE wakes up during an on-duration of a predetermined UE discontinuous reception; or
a second wake-up signal configured to indicate whether the UE wakes up during a predetermined paging occasion.

In an implementation, the first wake-up signal may be monitored by the UE that is in an RRC connected state.

In an implementation, the second wake-up signal may be monitored by the UE that is in an RRC unconnected state, and the RRC unconnected state may include at least one of an RRC idle state or an RRC non-active state.

In the present disclosure, the first wake-up signal may be a UE connected discontinuous reception (C-DRX) WUS (referred to as a C-DRX WUS, a DRX WUS, or a UE DRX WUS) for indicating whether the UE wakes up during the on-duration of the predetermined UE discontinuous reception and monitors the PDCCH. The on-duration of the predetermined UE discontinuous reception may be the on-duration of the UE discontinuous reception adjacent to the UE DRX WUS.

In the present disclosure, the first wake-up signal may be a paging wake-up signal (paging WUS), i.e., PEI, configured to indicate whether the UE wakes up during a predetermined paging occasion and monitors paging scheduling information. The predetermined paging occasion may be a paging occasion adjacent to the PEI.

In an implementation, the wake-up signal being invalid may include the wake-up signal being configured not to wake up the UE.

In an implementation, the UE DRX WUS is invalid, i.e., the UE DRX WUS is not configured to indicate whether the UE wakes up during the on-duration of the predetermined UE discontinuous reception and monitors the PDCCH. Thus, the UE may no longer monitor the UE DRX WUS.

In an implementation, the PEI is invalid, i.e., the PEI is not configured to indicate whether the UE wakes up during the predetermined paging occasion and monitors the paging scheduling information. Thus, the UE may no longer monitor the PEI.

In an implementation, the network device may transmit configuration information to the UE to indicate whether the wake-up signal associated with the cell discontinuous transmission is valid or invalid. For example, the configuration information may indicate that a wake-up signal transmitted by the network device during the active duration of the cell discontinuous transmission is invalid.

The wake-up signal may have a monitoring duration. The monitoring duration may be pre-configured by the network device or specified by the communication protocol. The network device can transmit the wake-up signal during the monitoring duration.

In an implementation, the monitoring duration may include the monitoring duration for the UE DRX WUS. In an implementation, the monitoring duration may include a time period from a starting time for the PEI monitoring to a starting time for a PEI-associated PO. The PEI-associated PO may include the first PO after the PEI, i.e., the PO after the PEI that is adjacent to the PEI.

In a case where the wake-up signal is valid, the UE can monitor the wake-up signal during the monitoring duration for the wake-up signal.

In this way, the UE may determine whether the wake-up signal associated with the cell discontinuous transmission is valid or invalid according to an indication of the configuration information. It is to reduce the cases where the UE does not monitor the wake-up signal and/or invalidly monitors the wake-up signal due to uncertainty as to whether the wake-up signal is valid or not.

In an embodiment, the configuration information is configured to indicate:
whether the wake-up signal is valid or invalid in a case where a cell is configured with the cell discontinuous transmission.

The configuration information transmitted by the network device may indicate that the wake-up signal is valid or invalid in a case where the cell is configured with the cell discontinuous transmission.

In an implementation, the network device may still transmit the wake-up signal regardless of whether the wake-up signal is valid or invalid.

In an implementation, in a case where the wake-up signal is invalid, the network device may not transmit the wake-up signal.

In an embodiment, the configuration information is configured to indicate at least one of the following:
whether the wake-up signal is valid or invalid during the non-active duration of the cell discontinuous transmission in a case where the cell is configured with the cell discontinuous transmission; or
whether the wake-up signal is valid or invalid during the non-active duration of the cell discontinuous transmission in a case where the cell is configured with the cell discontinuous transmission and a configuration of the cell discontinuous transmission is in an active state.

In an implementation, the cell discontinuous transmission may be in a form of configuration-as-activation, i.e., in a case where the cell is configured with the cell discontinuous transmission, the cell may perform communication using the cell discontinuous transmission. The configuration information transmitted by the network device may indicate that the wake-up signal is valid or invalid during the non-active duration of the cell discontinuous transmission in a case where the cell is configured with the cell discontinuous transmission.

In an implementation, the cell discontinuous transmission configured for the cell needs to be activated for implementation, i.e., in a case where the cell is configured with the cell discontinuous transmission, this configuration needs to be activated (e.g., activated by an activation command). After activation of the configuration, the cell may perform communication using the cell discontinuous transmission. The configuration information transmitted by the network device may indicate that in a case where the cell is configured with the cell discontinuous transmission and this configuration is activated, the wake-up signal is valid or invalid during the non-active duration of the cell discontinuous transmission.

For example, in a case where the wake-up signal (at least one of the UE DRX WUS or the PEI) is valid during the non-active duration of the cell discontinuous transmission, then:
1. the UE DRX WUS is not affected by the operation of the cell discontinuous transmission, i.e., the UE DRX WUS is transmitted normally during the non-active duration of the cell discontinuous transmission. The UE may monitor the UE DRX WUS during the non-active duration of the cell discontinuous transmission.
2. The PEI is not affected by the operation of the cell discontinuous transmission, i.e., the PEI is transmitted normally during the non-active duration of the cell discontinuous transmission. The UE may monitor the PEI during the non-active duration of the cell discontinuous transmission.

For example, the UE determines whether the PEI is affected by the operation of the cell discontinuous transmission based on the indication of the configuration information from the network device. If yes, the PEI is not monitored during the non-active duration of the cell discontinuous transmission.

In an embodiment, the configuration information is configured to indicate:
whether the wake-up signal is valid or invalid in a case where the monitoring duration for the wake-up signal and the non-active duration of the cell discontinuous transmission have an overlapping duration in the time domain.

In the present disclosure, the wake-up signal includes the UE DRX WUS and the PEI.

In an implementation, as shown in FIG. 2, the monitoring duration may include the monitoring duration for the UE DRX WUS (i.e., a duration for PS-RNTI monitor). The monitoring duration for the UE DRX WUS may be configured by the network device to the UE.

In an implementation, as shown in FIG. 3, the monitoring duration may include a time period from the starting time for the PEI monitoring (i.e., a starting time for PEI-RNTI monitor) to the starting time for the PEI-associated PO. The PEI-associated PO may include the first PO after the PEI, i.e., the PO after the PEI that is adjacent to the PEI.

The UE may determine whether the wake-up signal is valid in a case where the monitoring duration for the wake-up signal and the non-active duration of the cell discontinuous transmission have the overlapping duration in the time domain, according to the indication of the configuration information transmitted by the network device.

In an embodiment, a length of the overlapping duration is less than a length of the monitoring duration;
or,
the length of the overlapping duration is equal to the length of the monitoring duration.

In the present disclosure, the length of the overlapping duration is less than the length of the monitoring duration, i.e., a part of the monitoring duration for the wake-up signal overlaps with the non-active duration of the cell discontinuous transmission. The length of the overlapping duration is equal to the length of the monitoring duration, i.e., the entire monitoring duration for the wake-up signal overlaps with the non-active duration of the cell discontinuous transmission, i.e., the monitoring duration for the wake-up signal falls within the non-active duration of the cell discontinuous transmission.

In an embodiment, the configuration information is configured to indicate at least one of the following:
whether the wake-up signal during the monitoring duration is valid or invalid in a case where the monitoring duration for the wake-up signal and the non-active duration of the cell discontinuous transmission have the overlapping duration in the time domain; or
whether the wake-up signal during the non-active duration of the cell discontinuous transmission is valid or invalid in a case where the monitoring duration for the wake-up signal and the non-active duration of the cell discontinuous transmission have the overlapping duration in the time domain.

The UE may determine a duration in which the wake-up signal is valid or invalid in a case where the monitoring duration for the wake-up signal and the non-active duration of the cell discontinuous transmission have the overlapping duration in the time domain, according to the indication of the configuration information transmitted by the network device.

For example, in a case where the monitoring duration for the UE DRX WUS falls within the non-active duration of the cell discontinuous transmission, and/or a part of the monitoring duration for the UE DRX WUS falls within the non-active duration of the cell discontinuous transmission, the UE considers that the UE DRX WUS transmission in the monitoring duration for the UE DRX WUS is invalid, and the UE may not monitor the UE DRX WUS. The UE may monitor the PDCCH during a following UE DRX on-duration.

For example, in a case where a part of the monitoring duration for the UE DRX WUS falls within the non-active duration of the cell discontinuous transmission, the UE considers that the WUS transmission in the monitoring duration for the UE DRX WUS is valid and monitors the WUS (i.e., DCI 2-6 scrambled by a PS-RNTI) during the monitoring duration for the WUS. The UE may decide, based on a WUS indication, whether to monitor the PDCCH during the following UE DRX on-duration.

For example, in a case where the starting time for the paging wake-up signal (paging WUS) (i.e., PEI) falls within the non-active duration of the cell discontinuous transmission, or in a case where a part of a period from the starting time for the PEI to the PO reception falls within the non-active duration of the cell discontinuous transmission, or in a case where the entire period from the starting time for the PEI to the PO reception falls within the non-active duration of the cell discontinuous transmission, the UE considers that the PEI transmission in the PEI is invalid. The UE may not monitor the PEI and monitor the PDCCH during the following PO.

For example, in a case where a part of the period from the starting time for the paging wake-up signal (paging WUS) (i.e., PEI) to the PO reception falls within the non-active duration of the cell discontinuous transmission, the UE considers that the PEI is valid, starts to monitor the PEI (i.e., DCI 2-7 scrambled by a PEI-RNTI) at the starting time for the PEI, and determines, based on the WUS indication, whether to monitor the PDCCH during the following PO.

For example, based on a network device configuration indication, for scenarios where a part of the period from the starting time for the paging wake-up signal (paging WUS) (i.e., PEI) to the PO reception falls within the non-active duration of the cell discontinuous transmission, and/or the entire period from the starting time for PEI to the PO reception falls within the non-active duration of the cell discontinuous transmission, the UE determines whether the PEI is affected by the operation of the cell discontinuous transmission. In a case where the UE determines that the PEI is affected by the operation of the cell discontinuous transmission, the PEI is not monitored during the non-active duration of cell discontinuous transmission.

In the example, the duration from the starting time for the PEI to the PO reception is the monitoring duration for the PEI.

In an embodiment, the configuration information is configured to indicate at least one of the following:
whether the wake-up signal transmitted during a duration, during the monitoring duration for the wake-up signal, in which the monitoring duration and the non-active duration do not overlap in the time domain is valid or invalid, in a case where the monitoring duration for the wake-up signal and the non-active duration of the cell discontinuous transmission have the overlapping duration in the time domain; or
whether the wake-up signal is valid or invalid during the overlapping duration in a case where the monitoring duration for the wake-up signal and the non-active duration of the cell discontinuous transmission have the overlapping duration in the time domain.

The configuration information transmitted by the network device may indicate at least one of whether the wake-up signal is valid during the overlapping duration of the monitoring duration for the wake-up signal and the non-active duration of the cell discontinuous transmission, or whether the wake-up signal is valid during a non-overlapping part of the monitoring duration for the wake-up signal.

For example, in a case where a part of the period from the starting time for the paging wake-up signal (paging WUS) (i.e., PEI) to the PO reception falls within the non-active duration of the cell discontinuous transmission, the UE considers that the PEI is valid, and monitors the PEI (i.e., DCI 2-7 scrambled by a PEI-RNTI) after the starting time for the PEI and during the active duration of the cell discontinuous transmission. That is, the PEI is valid during the active duration of the cell discontinuous transmission, and the UE may monitor the PEI within an intersection of the monitoring duration for the PEI and the active duration of the cell discontinuous transmission. The UE may decide, based on a PEI indication, whether to monitor the PDCCH during a following PO duration.

In an embodiment, the UE determines that the wake-up signal is invalid, and monitors the physical downlink control channel (PDCCH) during an on-duration of UE discontinuous reception after the monitoring duration for the wake-up signal.

In an embodiment, the UE determines that the wake-up signal is invalid, and monitors a paging message during a paging occasion after the monitoring duration for the wake-up signal.

The on-duration of the UE discontinuous reception after the monitoring duration for the wake-up signal may be an on-duration of a predetermined UE discontinuous reception associated with the wake-up signal.

The paging occasion after the monitoring duration for the wake-up signal may be a predetermined paging occasion associated with the wake-up signal. Monitoring the paging message may include: monitoring paging scheduling information for the paging message, and then receiving the paging message according to the paging scheduling information.

In an implementation, the wake-up signal may be the UE DRX WUS. In a case where the UE DRX WUS is invalid, the UE DRX WUS is not configured to indicate whether the UE wakes up during the on-duration of the UE discontinuous reception after the UE DRX WUS and monitors the PDCCH. Thus, the UE cannot determine, according to the UE DRX WUS, whether it needs to monitor the PDCCH during the on-duration of the UE discontinuous reception after the UE DRX WUS. To reduce UE's missed reception of scheduling information transmitted by the network device, the UE may wake up and monitor the PDCCH during the on-duration of the UE discontinuous reception after the UE DRX WUS. In this way, a situation in which the scheduling information transmitted by the network device is missed due to an invalid wake-up signal may be reduced.

In an implementation, the wake-up signal may be the PEI. In a case where the PEI is invalid, the PEI is not configured to indicate whether the UE wakes up during a PO after the PEI and monitors the paging message. Thus, the UE cannot determine whether it needs to monitor the paging message during the PO after the PEI according to the PEI. To reduce UE's missed reception of the paging message transmitted by the network device, the UE may wake up during the PO after the PEI, and monitor the paging message. In this way, a situation of missed reception of the paging message transmitted by the network device due to invalidness of the wake-up signal may be reduced.

In an embodiment, the UE determines that the wake-up signal is valid, and monitors the wake-up signal during a duration in which the wake-up signal is valid.

In an embodiment, the UE determines that the wake-up signal is invalid, and does not monitor the wake-up signal during a duration in which the wake-up signal is invalid.

The UE may determine the duration when the wake-up signal is valid and/or invalid based on the configuration information.

For example, the UE may determine, based on the configuration information, that the wake-up signal is valid during the non-active duration of the cell discontinuous transmission, and then the non-active duration of the cell discontinuous transmission may be the duration in which the wake-up signal is valid. The UE may monitor the wake-up signal during the duration in which the wake-up signal is valid, i.e., the non-active duration of the cell discontinuous transmission.

In an implementation, the UE may monitor the wake-up signal during the duration in which the wake-up signal is valid may include: the UE may monitor the wake-up signal within an intersection of the valid duration for the wake-up signal and the monitoring duration for the wake-up signal.

For example, the UE may determine, based on the configuration information, that the wake-up signal is invalid during the non-active duration of the cell discontinuous transmission, and then the non-active duration of the cell discontinuous transmission may be the duration in which the wake-up signal is invalid. The UE may not monitor the wake-up signal during the duration in which the wake-up signal is invalid, i.e., the non-active duration of cell discontinuous transmission.

In an implementation, the network device may transmit the wake-up signal during the duration in which the wake-up signal is valid.

In an implementation, the network device may not transmit the wake-up signal during the duration in which the wake-up signal is invalid.

A plurality of specific examples are provided below in combination with any embodiment above.

Example 1: the manner in which RRC connected a UE receives a WUS in a network energy saving (NES) mode may include, but is not limited to, at least one of the following manners 1 to 4.

In manner 1, the UE connected discontinuous reception wake-up signal (UE C-DRX WUS) (referred to as UE DRX WUS, DRX WUS, or WUS) is not affected by the operation of the cell discontinuous transmission (cell DTX), i.e., the UE C-DRX WUS is transmitted normally during the cell DTX non-active duration.

In manner 2, in a case where the monitoring duration for the WUS falls in the non-active duration of the cell DTX, and/or a part of the monitoring duration for the WUS falls in the non-active duration of the cell DTX, the UE considers that the WUS transmission in the monitoring duration for the WUS is invalid and does not monitor that WUS. The UE monitors the PDCCH during the following UE C-DRX on-duration.

In manner 3, in a case where a part of the monitoring duration for the WUS falls in the non-active duration of the cell DTX, the UE considers that the WUS transmission in the monitoring duration for the WUS is valid and monitors the WUS, i.e., DCI 2-6 scrambled by a PS-RNTI, in the monitoring duration for the WUS. The UE decides, based on a WUS indication, whether to monitor the PDCCH during a following UE C-DRX on-duration.

In manner 4, based on an indication of the network device configuration, the UE determines whether the WUS is valid, i.e., whether the UE monitors the WUS during the monitoring duration for the WUS, i.e., DCI 2-6 scrambled by a PS-RNTI, in a case where the monitoring duration for the WUS falls within the non-active duration of the cell DTX and/or a part of the monitoring duration for the WUS falls within the non-active duration of the cell DTX.

Example 2: the manner in which UE in an RRC idle state/UE in an RRC non-active state receives a WUS in a network energy saving mode may include, but is not limited to, at least one of the following manners 5 to 9.

In manner 5, a paging WUS (i.e., PEI) is not affected by the operation of the cell DTX, i.e., the UE paging WUS (i.e., PEI) is transmitted normally during the non-active duration of the cell DTX.

In manner 6, in a case where the starting time for the paging wake-up signal (i.e., PEI) falls within the non-active duration of the cell DTX, or a part of a period from the starting time for the paging wake-up signal (i.e., PEI) to the PO reception falls within the non-active duration of the cell DTX, or the entire period from the starting time for the paging wake-up signal (i.e., PEI) to the PO reception falls within the non-active duration of the cell DTX, the UE considers that the PEI transmission in the paging wake-up signal (i.e., PEI) is invalid. The UE monitors the PDCCH during the following PO duration.

In manner 7.1, in a case where a part of the period from the starting time for the paging wake-up signal (i.e., PEI) to the PO reception falls within the non-active duration of the cell DTX, the UE considers that the paging wake-up signal (i.e., PEI) is valid, and starts to monitor the PEI (i.e., DCI 2-7 scrambled by a PEI-RNTI) at the starting time for the paging wake-up signal (i.e., PEI). The UE decides, based on the WUS indication, whether to monitor the PDCCH during the following PO duration.

In manner 7.2, in a case where a part of the period from the starting time for the paging wake-up signal (i.e., PEI) to the PO reception falls within the non-active duration of the cell DTX, the UE considers that the paging wake-up signal (i.e., PEI) is valid, and monitors the PEI (i.e., DCI 2-7 scrambled by a PEI-RNTI) after the starting time for the paging wake-up signal (i.e., PEI) and during the active duration of the cell DTX. The UE decides, based on the WUS indication, whether to monitor the PDCCH during the following PO duration.

In manner 8, based on the indication of the network device configuration, the UE determines whether the paging wake-up signal (i.e., PEI) is affected by the operation of the cell DTX. In a case where the UE determines that the paging wake-up signal is affected by the operation of the cell DTX, the PEI is not monitored during the non-active duration of the cell DTX.

In manner 9, based on the indication of the network device configuration, in a case where a part of the period from the starting time for the paging wake-up signal (i.e., PEI) to the PO reception falls within the non-active duration of the cell DTX, and/or the entire period from the starting time for the paging wake-up signal (i.e., PEI) to the PO reception falls within the non-active duration of the cell DTX, the UE determines whether the paging wake-up signal (i.e., PEI) is affected by the operation of the cell DTX. In a case where the UE determines that the paging wake-up signal is affected by the operation of the cell DTX, the PEI is not monitored during the non-active duration of the cell DTX.

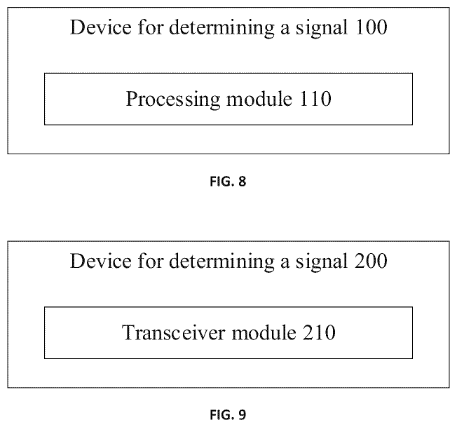

As shown in FIG. 8, an embodiment of the present disclosure provides a device 100 for determining a signal, arranged in a user equipment (UE), including:
a processing module 110 configured to determine whether a wake-up signal associated with cell discontinuous transmission is valid or invalid according to a communication protocol provision or configuration information from a network device.

In an embodiment, the processing module 110 is configured to:
determine whether the wake-up signal is valid or invalid in a case where a cell is configured with the cell discontinuous transmission.

In an embodiment, the processing module 110 is configured to do at least one of the following:
determine whether the wake-up signal is valid or invalid during a non-active duration of the cell discontinuous transmission in a case where the cell is configured with the cell discontinuous transmission; or
determine whether the wake-up signal is valid or invalid during a non-active duration of the cell discontinuous transmission in a case where the cell is configured with the cell discontinuous transmission and a configuration of the cell discontinuous transmission is in an active state.

In an embodiment, the processing module 110 is configured to:
determine whether the wake-up signal is valid or invalid in a case where a monitoring duration for the wake-up signal and the non-active duration of the cell discontinuous transmission have an overlapping duration in a time domain.

In an embodiment, the processing module 110 is configured to do at least one of the following:
determine whether the wake-up signal during the monitoring duration is valid or invalid in a case where the monitoring duration for the wake-up signal and the non-active duration of the cell discontinuous transmission have the overlapping duration in the time domain; or
determine whether the wake-up signal during the non-active duration of the cell discontinuous transmission is valid or invalid in a case where the monitoring duration for the wake-up signal and the non-active duration of the cell discontinuous transmission have the overlapping duration in the time domain.

In an embodiment, the processing module 110 is configured to do at least one of the following:
determine whether the wake-up signal transmitted during a duration, during the monitoring duration for the wake-up signal, in which the monitoring duration and the non-active duration do not overlap in the time domain is valid or invalid, in a case where the monitoring duration for the wake-up signal and the non-active duration of the cell discontinuous transmission have the overlapping duration in the time domain; or
determine whether the wake-up signal is valid or invalid during the overlapping duration in a case where the monitoring duration for the wake-up signal and the non-active duration of the cell discontinuous transmission have the overlapping duration in the time domain.

In an embodiment, a length of the overlapping duration is less than a length of the monitoring duration;
or,
a length of the overlapping duration is equal to a length of the monitoring duration.

In an embodiment, the processing module 110 is further configured to do at least one of the following:
determine that the wake-up signal is valid, and monitor the wake-up signal during a duration in which the wake-up signal is valid; or
determine that the wake-up signal is invalid, and not monitor the wake-up signal during a duration in which the wake-up signal is invalid.

In an embodiment, the processing module 110 is further configured to do at least one of the following:
determine that the wake-up signal is invalid, and monitor a physical downlink control channel (PDCCH) during an on-duration of UE discontinuous reception after the monitoring duration for the wake-up signal; or
determine that the wake-up signal is invalid, and monitor a paging message during a paging occasion after the monitoring duration for the wake-up signal.

In an embodiment, the wake-up signal includes at least one of the following:
a first wake-up signal configured to indicate whether the UE wakes up during an on-duration of a predetermined UE discontinuous reception; or
a second wake-up signal configured to indicate whether the UE wakes up during a predetermined paging occasion.

As shown in FIG. 9, an embodiment of the present disclosure provides a device 200 for determining a signal, arranged in a network device, including:
a transceiver module 210 configured to transmit configuration information, where the configuration information is configured to indicate whether a wake-up signal associated with cell discontinuous transmission is valid or invalid.

In an embodiment, the configuration information is configured to indicate:
whether the wake-up signal is valid or invalid in a case where a cell is configured with the cell discontinuous transmission.

In an embodiment, the configuration information is configured to indicate at least one of the following:
whether the wake-up signal is valid or invalid during a non-active duration of the cell discontinuous transmission in a case where the cell is configured with the cell discontinuous transmission; or
whether the wake-up signal is valid or invalid during a non-active duration of the cell discontinuous transmission in a case where the cell is configured with the cell discontinuous transmission and a configuration of the cell discontinuous transmission is in an active state.

In an embodiment, the configuration information is configured to indicate:
whether the wake-up signal is valid or invalid in a case where a monitoring duration for the wake-up signal and the non-active duration of the cell discontinuous transmission have an overlapping duration in a time domain.

In an embodiment, the configuration information is configured to indicate at least one of the following:
whether the wake-up signal during the monitoring duration is valid or invalid in a case where the monitoring duration for the wake-up signal and the non-active duration of the cell discontinuous transmission have the overlapping duration in the time domain; or
whether the wake-up signal during the non-active duration of the cell discontinuous transmission is valid or invalid in a case where the monitoring duration for the wake-up signal and the non-active duration of the cell discontinuous transmission have the overlapping duration in the time domain.

In an embodiment, the configuration information is configured to indicate at least one of the following:
whether the wake-up signal transmitted during a duration in which the monitoring duration and the non-active duration do not overlap in the time domain is valid or invalid during the monitoring duration for the wake-up signal, in a case where the monitoring duration for the wake-up signal and the non-active duration of the cell discontinuous transmission have the overlapping duration in the time domain; or
whether the wake-up signal is valid or invalid during the overlapping duration in a case where the monitoring duration for the wake-up signal and the non-active duration of the cell discontinuous transmission have the overlapping duration in the time domain.

In an embodiment, a length of the overlapping duration is less than a length of the monitoring duration;
or,
a length of the overlapping duration is equal to a length of the monitoring duration.

In an embodiment, the wake-up signal includes at least one of the following:
a first wake-up signal configured to indicate whether a user equipment (UE) wakes up during an on-duration of a predetermined UE discontinuous reception; or
a second wake-up signal configured to indicate whether the UE wakes up during a predetermined paging occasion.

An embodiment of the present disclosure provides a communication device, including:
a processor; and
a memory configured to store processor-executable instructions.

The processor is configured to implement the method for determining the signal of any embodiment of the present disclosure when executing the processor-executable instructions.

In an embodiment, the communication device may include, but is not limited to, at least one of: a network control repeater or a network device. In the present disclosure, the network device may include a core network or an access network device, etc. In the present disclosure, the access network device may include an access network device; and the core network may include an access and mobility management function (AMF) and a session management function (SMF).

The processor may include various types of storage media. The storage media are non-transitory computer storage media, and can continue to memorize information stored after the user equipment is powered down.

The processor may be connected with the memory via a bus and the like, and is configured to read the executable program stored on the memory, such as at least one of the methods shown in FIG. 4 to FIG. 7.

An embodiment of the present disclosure further provides a computer storage medium, storing a computer executable program, and when executed by a processor, the executable program implements the method for determining the signal of any embodiment of the present disclosure, for example, at least one of the methods as shown in FIG. 4 to FIG. 7.

As for the device or storage media in the embodiment, a specific mode in which each module performs operations is described in detail in the embodiments of the method, which will not be described in detail in the present disclosure.

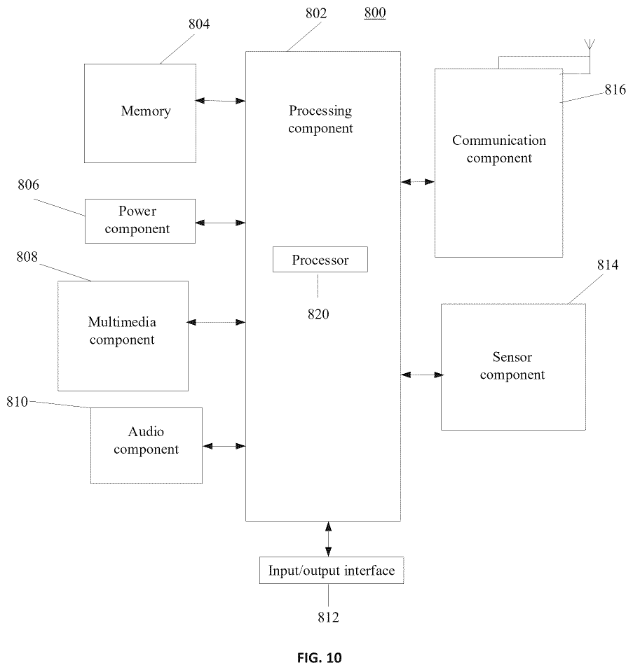

FIG. 10 is a block diagram of a UE 800 illustrated according to an example. For example, the UE 800 may be a mobile phone, a computer, digital broadcasting user equipment, a messaging device, a game console, a tablet device, a medical device, a fitness device, a personal digital assistant, etc.

Referring to FIG. 10, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the UE 800, such as operations associated with display, telephone call, data communication, camera operations, and recording operations. The processing component 802 may include one or more processors 820 to execute instructions to generate all or part of the steps of the method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of these data include instructions for any application or method operating on the UE 800, contact data, phonebook data, messages, pictures, videos, etc. The memory 804 may be implemented by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power for various components of the UE 800. The power component 806 may include a power management system, one or more power sources, and other components associated with generating, managing, and distributing power for the UE 800.

The multimedia component 808 includes a screen providing an output interface between the UE 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding, and gestures on the touch panel. The touch sensor can not only sense a boundary of the touch or sliding operation, but also detect the duration and pressure related to the touch or sliding operation. In some embodiments, the multimedia component 808 includes at least one of a front camera or a rear camera. When the UE 800 is in an operation mode, such as a shooting mode or a video mode, at least one of the front camera or the rear camera can receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the UE 800 is in the operation mode, such as a call mode, a recording mode, and a speech recognition mode. The received audio signal may be further stored in the memory 804 or transmitted via the communication component 816. In some embodiments, the audio component 810 also includes a speaker for outputting the audio signal.

The I/O interface 812 provides an interface between the processing component 802 and a peripheral interface module which may be a keyboard, a click wheel, a button, etc. These buttons may include but are not limited to: a home button, a volume button, a start button and a lock button.

The sensor component 814 includes one or more sensors for providing state evaluations of various aspects of the UE 800. For example, the sensor component 814 can detect an on/off state of the UE 800 and the relative positioning of the components, for example, the component is a display and a keypad of the UE 800. The sensor component 814 can also detect the change of the position of the UE 800 or one component of the UE 800, the presence or absence of user contact with the UE 800, the azimuth or acceleration/deceleration of the UE 800, and the temperature change of the UE 800. The sensor component 814 may include a proximity sensor configured to detect the presence of nearby objects without any physical contact. The sensor component 814 may further include an optical sensor, such as a complementary metal-oxide-semiconductor (CMOS) or charge-coupled device (CCD) image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G or 3G, or a combination of them. In an example, the communication component 816 receives a broadcast signal or broadcast-related information from an external broadcast management system via a broadcast channel. In an example, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example, the UE 800 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the method.

In an example, a non-transitory computer-readable storage medium including instructions, such as the memory 804 including instructions, which can be executed by the processor 820 of the UE 800 to generate the method, is also provided. For example, the non-transitory computer-readable storage medium may be an ROM, a random access memory (RAM), a compact disc read-only memory (CD-ROM), a magnetic tape, a floppy disk, an optical data storage device, etc.

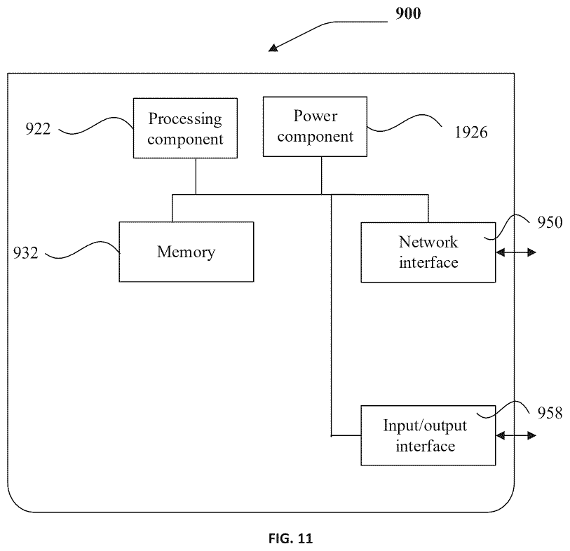

As shown in FIG. 11, an embodiment of the present disclosure shows a structure of an access device. For example, a communication device 900 may be provided as one network device. The communication device may be various network elements such as at least one of the aforementioned access network element or the aforementioned network function.

Referring to FIG. 11, the communication device 900 includes a processing component 922, which further includes one or more processors, and a memory resource represented by a memory 932 for storing instructions, such as applications, that may be executed by the processing component 922. The applications stored in the memory 932 may include one or more modules each corresponding to a set of instructions. In addition, the processing component 922 is configured to execute the instructions to perform any method applied to the access device, such as the method shown in any one of FIG. 4 to FIG. 7.

The communication device 900 may further include a power component 1926 configured to perform power management of the communication device 900, a wired or wireless network interface 950 configured to connect the communication device 900 to the network, and an input/output (I/O) interface 958. The communication device 900 can operate an operating system based on the memory 932, such as Windows Serve™, Mac OS X™, Unix™, Linux™, FreeBSD™, or the like.

The embodiments of the present disclosure provide a method and device for determining a signal, a communication device, and a storage medium. The UE determines whether the wake-up signal associated with the cell discontinuous transmission is valid or invalid according to the communication protocol provision or the configuration information from the network device. In this way, the UE may determine whether the wake-up signal associated with the cell discontinuous transmission is valid or invalid according to the communication protocol provision or the indication of the configuration information. This may reduce the cases where the UE does not monitor the wake-up signal and/or invalidly monitors the wake-up signal due to uncertainty as to whether the wake-up signal is valid or not.

As used herein, the term “processor” may refer to one processor that performs the defined functions or a plurality of processors that collectively perform defined functions, such that the execution of the individual defined functions may be divided amongst such processors.

Without contradictions, each step in one of the implementations or embodiments may be implemented as an independent embodiment, and the steps may be combined in any way, for example, the solution after removing some steps in one of the implementations or embodiments may also be implemented as an independent embodiment, and the order of the steps in one of the implementations or embodiments may be exchanged arbitrarily. Furthermore, optional ways or optional examples in a certain implementation or embodiment may be combined in any way. In addition, there may be any combination between the implementations or embodiments, e.g., some or all of the steps of different implementations or embodiments may be combined in any way, and a certain implementation or embodiment may be combined in any way with optional ways or optional examples of other implementations or embodiments.

Other implementations of the present disclosure will be apparent to those skilled in the art from consideration of the specification and practice of the disclosure in the present disclosure. The present disclosure is intended to cover any variations, uses, or adaptations of the present disclosure that follow the general principles of the present disclosure and include common knowledge or customary technical means in the technical field not disclosed in the present disclosure. The specification and the embodiments are considered as exemplary only, and a true scope and spirit of the present disclosure are indicated by the following claims.

It will be appreciated that the present disclosure is not limited to an exact construction that is described and illustrated in the accompanying drawings, and various modifications and changes may be made without departing from the scope of the present disclosure. The scope of the present disclosure is merely limited by the appended claims.

1. A method for determining a signal, performed by a user equipment (UE), the method comprising:
determining whether a wake-up signal associated with cell discontinuous transmission is valid or invalid according to a communication protocol provision or configuration information from a network device.

2. The method according to claim 1, wherein determining whether the wake-up signal associated with the cell discontinuous transmission is valid or invalid comprises:
determining whether the wake-up signal is valid or invalid in a case where a cell is configured with the cell discontinuous transmission.

3. The method according to claim 2, wherein determining whether the wake-up signal is valid or invalid in a case where the cell is configured with the cell discontinuous transmission comprises at least one of the following:
determining whether the wake-up signal is valid or invalid during a non-active duration of the cell discontinuous transmission in a case where the cell is configured with the cell discontinuous transmission; or
determining whether the wake-up signal is valid or invalid during a non-active duration of the cell discontinuous transmission in a case where the cell is configured with the cell discontinuous transmission and a configuration of the cell discontinuous transmission is in an active state.

4. The method according to claim 1, wherein determining whether the wake-up signal associated with the cell discontinuous transmission is valid or invalid comprises:
determining whether the wake-up signal is valid or invalid in a case where a monitoring duration for the wake-up signal and a non-active duration of the cell discontinuous transmission have an overlapping duration in a time domain.

5. The method according to claim 4, wherein determining whether the wake-up signal is valid or invalid in a case where the monitoring duration for the wake-up signal and the non-active duration of the cell discontinuous transmission have the overlapping duration in the time domain comprises at least one of the following:
determining whether the wake-up signal during the monitoring duration is valid or invalid in a case where the monitoring duration for the wake-up signal and the non-active duration of the cell discontinuous transmission have the overlapping duration in the time domain; or
determining whether the wake-up signal during the non-active duration of the cell discontinuous transmission is valid or invalid in a case where the monitoring duration for the wake-up signal and the non-active duration of the cell discontinuous transmission have the overlapping duration in the time domain.

6. The method according to claim 5, wherein determining whether the wake-up signal during the monitoring duration is valid or invalid in a case where the monitoring duration for the wake-up signal and the non-active duration of the cell discontinuous transmission have the overlapping duration in the time domain comprises at least one of the following:
determining whether the wake-up signal transmitted during a duration, during the monitoring duration for the wake-up signal, in which the monitoring duration and the non-active duration do not overlap in the time domain is valid or invalid, in a case where the monitoring duration for the wake-up signal and the non-active duration of the cell discontinuous transmission have the overlapping duration in the time domain; or
determining whether the wake-up signal is valid or invalid during the overlapping duration in a case where the monitoring duration for the wake-up signal and the non-active duration of the cell discontinuous transmission have the overlapping duration in the time domain.

7. The method according to claim 4, wherein
a length of the overlapping duration is less than a length of the monitoring duration;
or,
a length of the overlapping duration is equal to a length of the monitoring duration.

8. The method according to claim 1, wherein the method further comprises at least one of the following:
determining that the wake-up signal is valid, and monitoring the wake-up signal during a duration in which the wake-up signal is valid; or
determining that the wake-up signal is invalid, and not monitoring the wake-up signal during a duration in which the wake-up signal is invalid.

9. The method according to claim 1, further comprising at least one of the following:
determining that the wake-up signal is invalid, and monitoring a physical downlink control channel (PDCCH) during an on-duration of UE discontinuous reception after a monitoring duration for the wake-up signal; or
determining that the wake-up signal is invalid, and monitoring a paging message during a paging occasion after a monitoring duration for the wake-up signal.

10. The method according to claim 1, wherein the wake-up signal comprises at least one of the following:
a first wake-up signal configured to indicate whether the UE wakes up during an on-duration of a predetermined UE discontinuous reception; or
a second wake-up signal configured to indicate whether the UE wakes up during a predetermined paging occasion.

11. A method for determining a signal, performed by a network device, the method comprising:
transmitting configuration information, wherein the configuration information is configured to indicate whether a wake-up signal associated with cell discontinuous transmission is valid or invalid.

12. The method according to claim 11, wherein the configuration information is configured to indicate:
whether the wake-up signal is valid or invalid in a case where a cell is configured with the cell discontinuous transmission.

13. The method according to claim 12, wherein the configuration information is configured to indicate at least one of the following:
whether the wake-up signal is valid or invalid during a non-active duration of the cell discontinuous transmission in a case where the cell is configured with the cell discontinuous transmission; or
whether the wake-up signal is valid or invalid during a non-active duration of the cell discontinuous transmission in a case where the cell is configured with the cell discontinuous transmission and a configuration of the cell discontinuous transmission is in an active state.

14. The method according to claim 11, wherein the configuration information is configured to indicate:
whether the wake-up signal is valid or invalid in a case where a monitoring duration for the wake-up signal and a non-active duration of the cell discontinuous transmission have an overlapping duration in a time domain.

15. The method according to claim 14, wherein the configuration information is configured to indicate at least one of the following:
whether the wake-up signal during the monitoring duration is valid or invalid in a case where the monitoring duration for the wake-up signal and the non-active duration of the cell discontinuous transmission have the overlapping duration in the time domain; or
whether the wake-up signal during the non-active duration of the cell discontinuous transmission is valid or invalid in a case where the monitoring duration for the wake-up signal and the non-active duration of the cell discontinuous transmission have the overlapping duration in the time domain.

16. The method according to claim 15, wherein the configuration information is configured to indicate at least one of the following:
whether the wake-up signal transmitted during a duration in which the monitoring duration and the non-active duration do not overlap in the time domain is valid or invalid during the monitoring duration for the wake-up signal, in a case where the monitoring duration for the wake-up signal and the non-active duration of the cell discontinuous transmission have the overlapping duration in the time domain; or
whether the wake-up signal is valid or invalid during the overlapping duration in a case where the monitoring duration for the wake-up signal and the non-active duration of the cell discontinuous transmission have the overlapping duration in the time domain.

17. The method according to claim 14, wherein
a length of the overlapping duration is less than a length of the monitoring duration;
or,
a length of the overlapping duration is equal to a length of the monitoring duration.

18. The method according to claim 11, wherein the wake-up signal comprises at least one of the following:
a first wake-up signal configured to indicate whether a user equipment (UE) wakes up during an on-duration of a predetermined UE discontinuous reception; or
a second wake-up signal configured to indicate whether a UE wakes up during a predetermined paging occasion.

19-21. (canceled)

22. A user equipment (UE), comprising one or more processors, a transceiver, a memory, and an executable program stored on the memory and executable by the one or more processors, wherein the executable program, when executed by the one or more processors, causes the UE to:
determine whether a wake-up signal associated with cell discontinuous transmission is valid or invalid according to a communication protocol provision or configuration information from a network device.

23. (canceled)

24. A network device, comprising one or more processors, a transceiver, a memory, and an executable program stored on the memory and executable by the one or more processors, wherein the executable program, when executed by the one or more processors, causes the network device to perform the method for determining the signal according to claim 11.
